(19) United States
(12) Patent Application Publication
(10) Pub. No.: US 2023/0245323 A1
(43) Pub. Date: Aug. 3, 2023

(54) OBJECT TRACKING DEVICE, OBJECT TRACKING METHOD, AND STORAGE MEDIUM

(71) Applicant: HONDA MOTOR CO., LTD., Tokyo (JP)

(72) Inventors: Satoru Araki, Wako-shi (JP); Masamitsu Tsuchiya, Wako-shi (JP)

(21) Appl. No.: 18/101,593

(22) Filed: Jan. 26, 2023

(30) Foreign Application Priority Data
Jan. 28, 2022 (JP) 2022-011761

(51) Int. Cl. G06T 7/20; G06T 7/70; G06V 20/58

(52) U.S. Cl. CPC G06T 7/20; G06T 7/70; G06V 20/58; G06T 2207/30252

(57) ABSTRACT

An object tracking device according to embodiments includes an image acquirer configured to acquire image data including a plurality of image frames captured in time series by an imager mounted on a mobile object, a recognizer configured to recognize an object from image data acquired by the image acquirer, an area setter configured to set an image area including an object recognized by the recognizer, and an object tracker configured to track the object on the basis of an amount of time-series change in an image area set by the area setter, in which the area setter sets a position and a size of an image area for tracking the object in the future image frame on the basis of the amount of time-series change in an image area including the object in the past image frame and behavior information of the mobile object.

### CROSS-REFERENCE TO RELATED APPLICATION

Priority is claimed on Japanese Patent Application No. 2022-011761, filed Jan. 28, 2022, the content of which is incorporated herein by reference.

### BACKGROUND

### Field of the Invention

The present invention relates to an object tracking device, an object tracking method, and a storage medium.

### Description of Related Art

Conventionally, a technology for performing signal processing based on pre-learned results on the basis of image data in front of a vehicle, captured by an in-vehicle camera, and detecting an object present in the vicinity of the vehicle is known (for example, Japanese Unexamined Patent Application, First Publication No. 2021-144689). In Japanese Unexamined Patent Application, First Publication No. 2021-144689, a deep neural network (DNN) such as a convolutional neural network is used to detect an object present in the vicinity of a vehicle.

### SUMMARY

However, when object tracking is performed on an image captured by an imager mounted on a mobile object as in the conventional technology, changes in the appearance of a tracking target and the amount of movement are greater than in still camera images, and accurate object tracking may not be possible in some cases.

The present invention has been made in consideration of such circumstances, and one object thereof is to provide an object tracking device, an object tracking method, and a storage medium capable of further improving the tracking accuracy of an object present in the vicinity of a vehicle.

The object tracking device, the object tracking method, and the storage medium according to the present invention have adopted the following configuration.
(1): An object tracking device according to one aspect of the present invention includes an image acquirer configured to acquire image data including a plurality of image frames captured in time series by an imager mounted on a mobile object, a recognizer configured to recognize an object from image data acquired by the image acquirer, an area setter configured to set an image area including an object recognized by the recognizer, and an object tracker configured to track the object on the basis of an amount of time-series change in an image area set by the area setter, in which the area setter sets a position and a size of an image area for tracking the object in the future image frame on the basis of the amount of time-series change in an image area including the object in the past image frame and behavior information of the mobile object.
(2): In the aspect of (1) described above, the area setter estimates a position and a speed of an object after a time point of recognition on the basis of an amount of change in the position of the object in the past prior to the time point of recognition of the object by the recognizer, and sets a position and a size of an image area for tracking the object in a future image frame on the basis of the estimated position and speed, and behavior information of the mobile object in the past prior to the time point of recognition.
(3): In the aspect of (1) described above, when the object is recognized by the recognizer, the area setter projects and converts an image captured by the imager into a bird's-eye view image, acquires a position and a size of the object in the bird's-eye view image, estimates a future position of the object in the bird's-eye view image on the basis of the acquired position and size of the object and the behavior information of the mobile object, and sets the position and size of an image area for tracking the object in a next image frame by associating the estimated position with the captured image.
(4): In the aspect of (1) described above, the object tracker uses a Kernelized Correlation Filter (KCF) for the tracking of the object.
(5): In the aspect of (1) described above, the area setter increases the size of the image area when the mobile object travels to avoid contact with the object, compared to the size when the mobile object does not travel to avoid the contact.
(6): An object tracking method according to another aspect of the present invention includes, by a computer, acquiring image data including a plurality of image frames captured in time series by an imager mounted on a mobile object, recognizing an object from the acquired image data, setting an image area including the recognized object, tracking the object on the basis of an amount of time-series change in the set image area, and setting a position and a size of an image area for tracking the object in a future image frame on the basis of the amount of time-series change in an image area including the object in a past image frame and behavior information of the mobile object.
(7): A storage medium according to still another aspect of the present invention is a computer-readable non-transitory storage medium that has stored a program causing a computer to execute acquiring image data including a plurality of image frames captured in time series by an imager mounted on a mobile object, recognizing an object from the acquired image data, setting an image area including the recognized object, tracking the object on the basis of an amount of time-series change in the set image area, and for tracking the object in a future image frame on the basis of the amount of time-series change in an image area including the object in a past image frame and behavior information of the mobile object.

According to the aspects of (1) to (7), it is possible to further improve tracking accuracy of an object present in the vicinity of a vehicle.

### BRIEF DESCRIPTION OF THE DRAWINGS

FIG. 1 is a diagram which shows an example of a configuration of an object tracking device mounted on a host vehicle M and peripheral equipment.

FIG. 2 is a diagram which shows an example of a surrounding situation of the host vehicle M in which an object tracking device is mounted.

FIG. 3 is a diagram which shows an example of an image in front of the host vehicle M, captured by a camera in the surrounding situation shown in FIG. 2.

FIG. 4 is a diagram which shows an example of a configuration of an area setter.

FIG. 5 is a diagram which shows an example of a grid configuration set by a grid extractor.

FIG. 6 is a diagram which shows an example of an extraction method of a grid G by the grid extractor.

FIG. 7 is a diagram which shows an example of a grid image calculated by the grid extractor.

FIG. 8 is a diagram which shows an example of a searching method of the grid G executed by an area controller.

FIG. 9 is a diagram which shows an example of a bounding box superimposed on an image.

FIG. 10 is a schematic diagram for describing image area setting and tracking processing.

FIG. 11 is a flowchart which shows an example of area setting processing.

FIG. 12 is a flowchart which shows an example of a flow of driving control processing executed by the object tracking device.

### DESCRIPTION OF EMBODIMENTS

Hereinafter, embodiments of an object tracking device, an object tracking method, and a storage medium of the present invention will be described with reference to the drawings. An object tracking device of an embodiment is mounted on, for example, a mobile object. Mobile objects are, for example, four-wheeled vehicles, two-wheeled vehicles, micro-mobility, robots that move by themselves, or portable devices such as smartphones that are placed on mobile objects that moves by themselves or are carried by people. In the following description, it is assumed that the mobile object is a four-wheeled vehicle, and the mobile object is referred to as a “host vehicle M” for description. The object tracking device is not limited to a device mounted on the mobile object, and may be a device that performs processing described below based on an image captured by a camera for fixed-point observation or a camera of a smartphone.

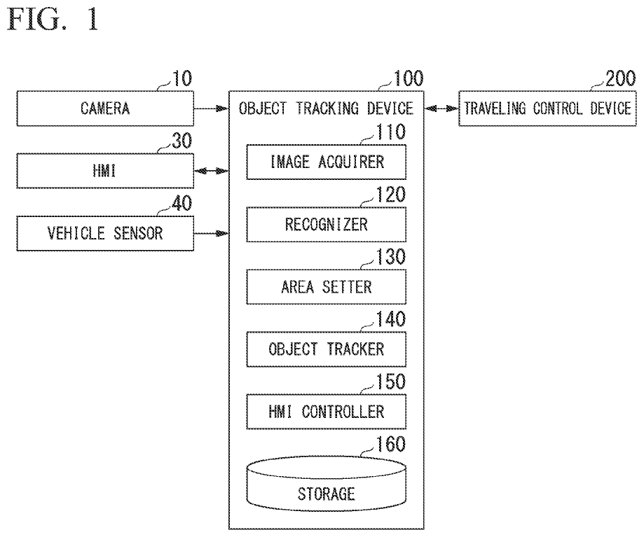

FIG. 1 is a diagram which shows an example of a configuration of the object tracking device 100 mounted in the host vehicle M and peripheral equipment. The object tracking device 100 communicates with, for example, a camera 10, an HMI 30, a vehicle sensor 40, and a traveling control device 200.

The camera 10 is attached to a rear surface of a windshield of the host vehicle M or the like, captures an image of an area including at least a road in a traveling direction of the host vehicle M in time series, and outputs the captured image to the object tracking device 100. A sensor fusion device or the like may be interposed between the camera 10 and the object tracking device 100, but description thereof will be omitted.

The HMI 30 presents various types of information to an occupant of the host vehicle M under control of the HMI controller 150 and receives an input operation by the occupant. The HMI 30 includes, for example, various display devices, speakers, switches, microphones, buzzers, touch panels, keys, and the like. Various display devices are, for example, liquid crystal display (LCD) and organic electro luminescence (EL) display devices, and the like. The display device is provided, for example, near a front of a driver's seat (a seat closest to a steering wheel) in an instrument panel, and is installed at a position where the occupant can see it through a gap between steering wheels or through the steering wheels. The display device may be installed in a center of the instrument panel. The display device may be a head up display (HUD). By projecting an image onto a part of the windshield in front of the driver's seat, the HUD causes a virtual image to be visible to the eyes of the occupant seated on the driver's seat. The display device displays an image generated by the HMI controller 150, which will be described below.

The vehicle sensor 40 includes a vehicle speed sensor for detecting a speed of the host vehicle M, an acceleration sensor for detecting an acceleration, a yaw rate sensor for detecting an angular speed (yaw rate) around a vertical axis, an orientation sensor for detecting a direction of the host vehicle M, and the like. The vehicle sensor 40 may also include a steering angle sensor that detects a steering angle of the host vehicle M (either an angle of the steering wheel or an operation angle of the steering wheel). The vehicle sensor 40 may include a sensor that detects an amount of depression of an accelerator pedal or a brake pedal. The vehicle sensor 40 may also include a position sensor that acquires a position of the host vehicle M. The position sensor is, for example, a sensor that acquires position information (longitude and latitude information) from a global positioning system (GPS) device. The position sensor may be, for example, a sensor that acquires position information using a global navigation satellite system (GNSS) receiver of a navigation device (not shown) mounted in the host vehicle M.

The object tracking device 100 includes, for example, an image acquirer 110, a recognizer 120, an area setter 130, an object tracker 140, an HMI controller 150, and a storage 160. These components are realized by, for example, a hardware processor such as a central processing unit (CPU) executing a program (software). Some or all of these components may be realized by hardware (circuit unit; including circuitry) such as large scale integration (LSI), an application specific integrated circuit (ASIC), a field-programmable gate array (FPGA), a graphics processing unit (GPU), and the like, or by software and hardware in cooperation. The program may be stored in advance in a storage device such as a hard disk drive (HDD) or flash memory (a storage device with a non-transitory storage medium), or may be stored in a detachable storage device such as a DVD or CD-ROM (a non-transitory storage medium), and may be installed by the storage medium being mounted on a drive device.

The storage 160 may be realized by the various storage devices described above, a solid state drive (SSD), an electrically erasable programmable read only memory (EEPROM), a read only memory (ROM), or a random access memory (RAM). The storage 160 stores, for example, information necessary for performing object tracking in the embodiment, tracking results, map information, programs, and various types of other information. The map information may include, for example, a road shape (road width, curvature, gradient), the number of lanes, intersections, information on a lane center or information on a lane boundary (a division line), and the like. The map information may include Point Of Interest (POI) information, traffic regulation information, address information (address/zip code), facility information, telephone number information, and the like.

The image acquirer 110 acquires images captured by the camera 10 in time series (hereinafter referred to as camera images). The image acquirer 110 may store the acquired camera images in the storage 160.

The recognizer 120 recognizes a surrounding situation of the host vehicle M on the basis of the camera image acquired by the image acquirer 110. For example, the recognizer 120 recognizes types, positions, speeds, accelerations, and the like of objects present in a vicinity of the host vehicle M (within a predetermined distance). Objects include, for example, other vehicles (including motorcycles), traffic participants such as pedestrians and bicycles, road structures, and the like. Road structures include, for example, road signs, traffic lights, curbs, medians, guardrails, fences, walls, railroad crossings, and the like. The position of an object is recognized, for example, as a position on absolute coordinates with a representative point (a center of gravity, a center of a drive shaft, or the like) of the host vehicle M as an origin, and is used for control. The position of an object may be represented by a representative point such as the center of gravity or a corner of the object, or may also be represented by an expressed area. A “state” of the object may also include an acceleration, jerk, or a “behavioral state” (for example, whether it is performing or about to perform a lane change) of the object. In the following description, it is assumed that the object is “another vehicle.”

The recognizer 120 may recognize crosswalks, stop lines, other traffic signs (speed limits, road signs), and the like drawn on a road on which the host vehicle M travels. The recognizer 120 may recognize the road division lines (hereinafter, referred to as division lines) that divide each lane included in the road on which the host vehicle M travels, and recognize a traveling lane of the host vehicle M from closest division lines existing on the left and right of the host vehicle M. The recognizer 120 may analyze an image captured by the camera 10 to recognize the division lines, may refer to map information stored in the storage 160 based on positional information of the host vehicle M detected by the vehicle sensor 40 to recognize information on surrounding division lines or the traveling lane based on the position of the host vehicle M, or may also integrate both results of these recognitions.

The recognizer 120 recognizes the position and a posture of the host vehicle M with respect to the traveling lane. The recognizer 120 may recognize, for example, a deviation of a reference point of the host vehicle M from a center of the lane and an angle of a vehicle body formed with respect to a line connecting centers of the lane in the traveling direction of the host vehicle M as relative position and posture of the host vehicle M with respect to the traveling lane. Alternatively, the recognizer 120 may recognize a position of the reference point of the host vehicle M with respect to either side end of the travel lane (a road division line or a road boundary), or the like as the relative position of the host vehicle M with respect to the traveling lane.

The recognizer 120 may analyze the image captured by the camera 10, and recognize the direction of a vehicle body of another vehicle with respect to a front direction of the host vehicle M or an extending direction of the lane, a width of the vehicle, a position and a direction of wheels of the another vehicle, and the like on the basis of feature information (for example, edge information, color information, information such as a shape and a size of the object) obtained from results of the analysis. The direction of the vehicle body is, for example, a yaw angle of the another vehicle (an angle of the vehicle body with respect to a line connecting the centers of a lane in a traveling direction of the another vehicle).

The area setter 130 sets an image area including an object in the camera image when the object is recognized by the recognizer 120. A shape of the image area may be, for example, a rectangular shape such as a bounding box, or may be another shape (for example, circular, or the like). The area setter 130 sets a position and a size of the image area when the object tracker 140 tracks the object in a future image frame on the basis of the amount of time-series change in the image area including the object in the past image frame and behavior information of the host vehicle M.

The object tracker 140 tracks the object included in the future image frame on the basis of the image area set by the area setter 130.

The HMI controller 150 uses the HMI 30 to notify the occupant of predetermined information, or acquires information received by the HMI 30 through an operation of the occupant. For example, the predetermined information to be notified to the occupant includes information related to traveling of the host vehicle M, such as information on the state of the host vehicle M and information on driving control. Information on the state of the host vehicle M includes, for example, the speed of the host vehicle M, an engine speed, a shift position, and the like. The predetermined information may include information on a tracking result of the object, information for warning that there is a possibility of coming into contact with the object, and information for prompting a driving operation to avoid contact. The predetermined information may include information not related to the driving control of the host vehicle M, such as television programs, content (for example, movies) stored in a storage medium such as a DVD.

For example, the HMI controller 150 may generate an image including the predetermined information described above and cause a display device of the HMI 30 to display the generated image, and may generate a sound indicating the predetermined information and output the generated sound from a speaker of the HMI 30.

The traveling control device 200 is, for example, an automated driving control device that controls one or both of steering and speed of the host vehicle M to cause the host vehicle M to autonomously travel, a driving support device that performs inter-vehicle distance control, automated brake control, automated lane change control, lane maintenance control, and the like, or the like. For example, the traveling control device 200 operates an automated driving control device, a driving support device, and the like on the basis of the information obtained by the object tracking device 100 to execute traveling control such as avoiding contact between the host vehicle M and an object being tracked.

[Function of object tracking device]

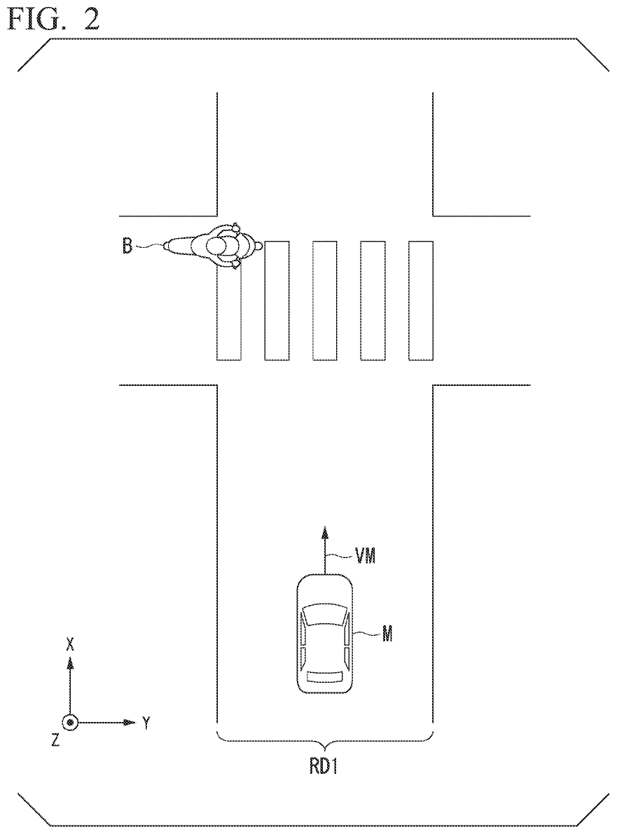

Next, details of functions of the object tracking device 100 will be described. FIG. 2 is a diagram which shows an example of the surrounding situation of the host vehicle M in which the object tracking device 100 is mounted. FIG. 2 shows, as an example, a scene in which a motorcycle B (an example of a target object) travels across a road RD1 in front of the host vehicle M while the host vehicle M in which the object tracking device 100 is mounted travels at a speed VM in an extending direction of the road RD1 (an X-axis direction in FIG. 2). In the following description, as an example, tracking of the motorcycle B by the object tracking device 100 will be described.

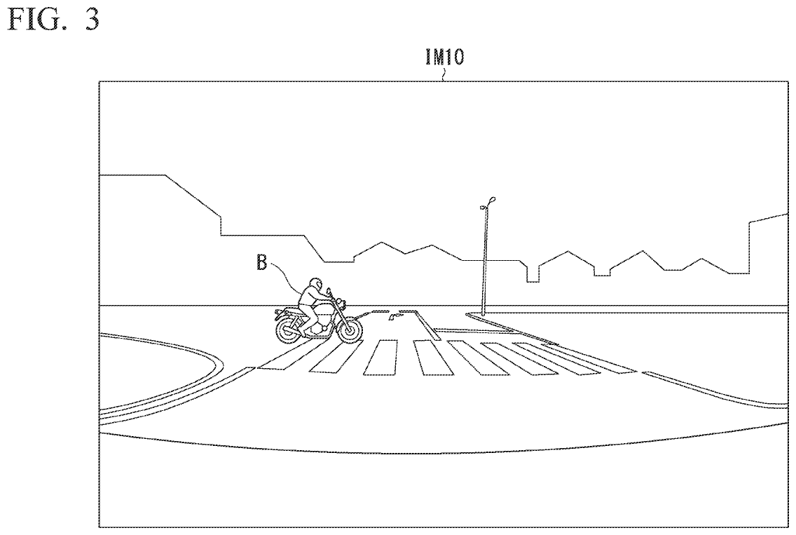

FIG. 3 is a diagram which shows an example of an image IM10 in front of the host vehicle M captured by the camera 10 in the surrounding situation shown in FIG. 2. The image acquirer 110 acquires image data including a plurality of frames representing the surrounding situation of the host vehicle M captured in time series by the camera 10 mounted in the host vehicle M. More specifically, for example, the image acquirer 110 acquires image data from the camera 10 at a frame rate of approximately 30 Hz, but the present invention is not limited thereto.

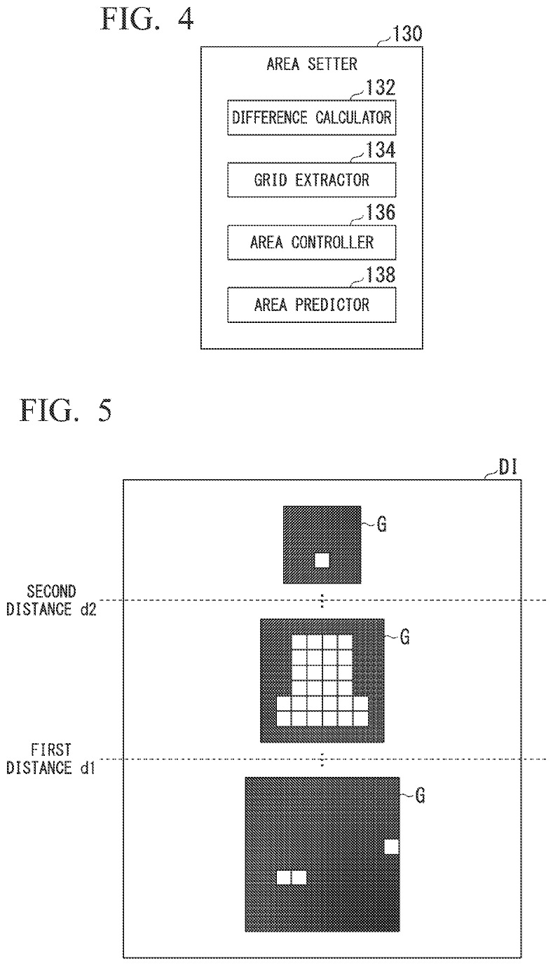

The recognizer 120 performs image analysis processing on the image IM10, acquires feature information (for example, feature information based on color, size, shape, and the like) for each object included in the image, and recognizes the motorcycle B by matching the acquired feature information with feature information of a predetermined target object. The recognition of the motorcycle B may include, for example, determination processing by artificial intelligence (AI) or machine learning. The area setter 130 sets an image area (bounding box) including the motorcycle B included in the image IM10. FIG. 4 is a diagram which shows an example of the configuration of the area setter 130. The area setter 130 includes, for example, a difference calculator 132, a grid extractor 134, an area controller 136, and an area predictor 138. For example, the difference calculator 132, the grid extractor 134, and the area controller 136 have a function of setting the image area including the motorcycle B recognized by the recognizer 120, and the area predictor 138 has a function of setting an image area in a next image frame.

The difference calculator 132 calculates a difference in pixel values in a plurality of frames acquired by the image acquirer 110 and binarizes the calculated difference into a first value (for example, 1) and a second value (for example, 0), thereby calculating a difference image DI between the plurality of frames.

More specifically, the difference calculator 132 first performs gray conversion on the plurality of frames acquired by the image acquirer 110, and converts an RGB image into a grayscale image. Next, the difference calculator 132 enlarges a frame captured at a previous time point (which may hereinafter be referred to as a “previous frame”) centered on a vanishing point of the frame on the basis of the speed of the host vehicle M in an image capturing interval at which the plurality of frames are captured, thereby aligning the frame with a frame captured at a current time point (which may hereinafter be referred to as a “current frame”).

For example, the difference calculator 132 estimates a movement distance of the host vehicle M based on the speed (average speed) of the host vehicle M measured between, for example, the previous time point and the current time point, and enlarges the previous frame centered on the vanishing point by an enlargement rate corresponding to the movement distance. The vanishing point is, for example, an intersection connected by extending both sides of the travel lane of the host vehicle M included in an image frame. The difference calculator 132 enlarges the previous frame by the enlargement rate corresponding to the movement distance of the host vehicle M measured between the previous time point and the current time point. At this time, because the size of the enlarged previous frame becomes larger than the size before enlargement, the difference calculator 132 trims an end of the enlarged previous frame to restore the size of the enlarged previous frame to an original size.

The difference calculator 132 may correct the previous frame in consideration of the yaw rate of the host vehicle M in the image capturing interval between the previous frame and the current frame in addition to the speed of the host vehicle M in the image capturing interval between the previous frame and the current frame. More specifically, the difference calculator 132 may calculate a difference between a yaw angle of the host vehicle M when the previous frame was acquired and a yaw angle of the host vehicle M when the current frame was acquired, on the basis of the yaw rate in the image capturing interval, and align the previous frame and the current frame by shifting the previous frame in the yaw direction by an angle corresponding to the difference.

Next, the difference calculator 132 aligns the previous frame with the current frame, and then calculates the difference in pixel values between the previous frame and the current frame. The difference calculator 132 assigns a first value indicating that it is a candidate for a target object to a corresponding pixel when the calculated difference value for each pixel is equal to or greater than a specified value. On the other hand, when the calculated difference value is less than the specified value, the difference calculator 132 assigns a second value indicating that it is not a candidate for a mobile object to a corresponding pixel.

The grid extractor 134 sets a grid for each of the plurality of pixels in the difference image DI calculated by the difference calculator 132, and when a density (proportion) of pixels having the first value in each of the set grids is equal to or greater than a threshold value, the grid extractor extracts a corresponding grid G. The grid G is a set of a plurality of pixels defined as a grid in the difference image DI.

FIG. 5 is a diagram which shows an example of a grid configuration set by the grid extractor 134. For example, as shown in FIG. 5, the grid extractor 134 sets a size of the grid G to about 10x10 pixels (an example of a “first size”) for an area whose distance from the camera 10 is equal to or less than a first distance (for example, 10 m), sets the size of the grid G to about 8x8 pixels (an example of a “second size”) for an area whose distance from the camera 10 is equal to or less than a second distance (for example, 20 m) greater than the first distance, and sets the size of the grid G to about 5x5 pixels (an example of a “third size”) for an area whose distance from the camera 10 is greater than the second distance in the difference image DI. This is because as the distance from the camera 10 increases, changes in an area imaged by the camera 10 become smaller, and the size of the grid G needs to be set more finely to detect a mobile object. By setting the size of the grid G according to the distance from the camera 10 in the difference image DI, it is possible to detect a mobile object more accurately.

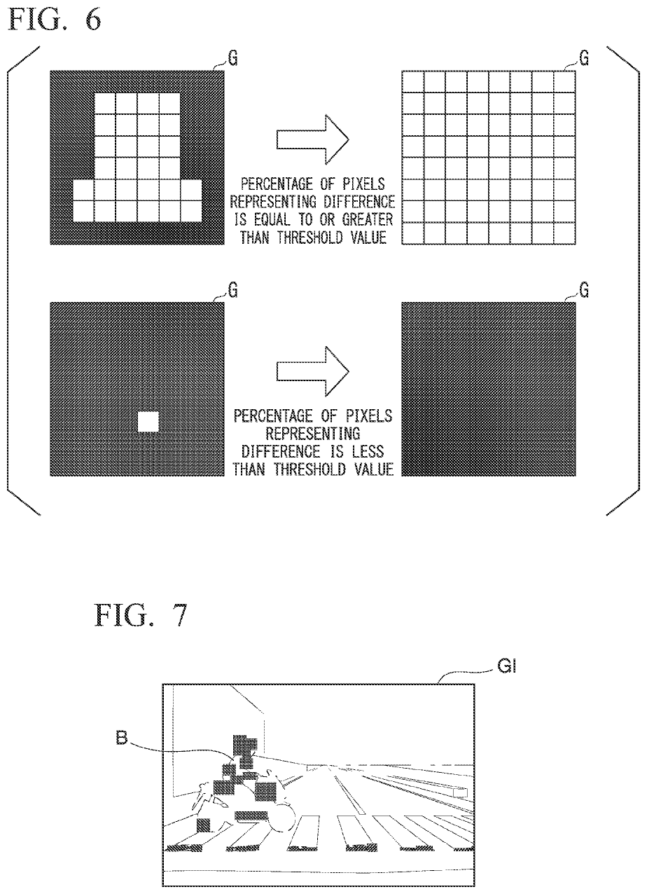

FIG. 6 is a diagram which shows an example of a method of extracting a grid G using the grid extractor 134. The grid extractor 134 determines whether the density of pixels having the first value is equal to or greater than a threshold value (for example, about 85%) for each of a plurality of grids G, and extracts, for a grid G for which it is determined that the density of pixels having the first value is equal to or greater than the threshold value, all of pixels that constitute the grid G (set to the first value) as shown in an upper part of FIG. 6. On the other hand, the grid extractor 134 discards, for a grid G for which it is determined that the density of pixels having the first value is less than the threshold value, all of the pixels constituting the grid G as shown in a lower part of FIG. 6 (set to the second value).

In the description above, the grid extractor 134 determines whether the density of pixels having the first value is equal to or greater than a single threshold value for each of the plurality of grids G. However, the present invention is not limited to such a configuration, and the grid extractor 134 may change the threshold value according to the distance from the camera 10 in the difference image DI. For example, in general, as the distance from the camera 10 decreases, the changes in an area captured by the camera 10 become larger, and an error is more likely to occur, and thus the grid extractor 134 may set the threshold value higher as the distance from the camera 10 decreases.

Furthermore, the grid extractor 134 may perform the determination using any statistical value based on the pixels having the first value, not limited to the density of the pixels having the first value.

The grid extractor 134 performs processing of setting all the pixels of the grid in which the density of the pixels having the first value is equal to or greater than the threshold value to the first value (grid replacement processing) on the difference image DI to calculate a grid image GI. FIG. 7 is a diagram which shows an example of the grid image GI calculated by the grid extractor 134. In the example of FIG. 7, for convenience of description, a part of a background image is left, but actually components of the grid image GI shown in FIG. 7 are not pixels but grids. By performing the grid replacement processing on the difference image DI in this manner, a grid representing the motorcycle B is detected.

The area controller 136 searches for a set of grids G that have been extracted by the grid extractor 134 and have satisfied a predetermined criterion, and sets a bounding box for the searched set of grids G.

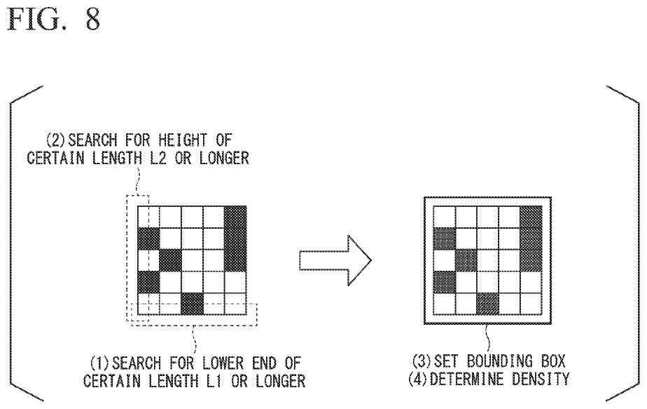

FIG. 8 is a diagram which shows an example of a method of searching for a grid G executed by the area controller 136. The area controller 136 first searches for a set of grids G having the lower end of a certain length L1 or longer from the grid image GI calculated by the grid extractor 134. At this time, as shown in a left part of FIG. 8, the area controller 136 does not necessarily require a condition that the set includes grids G without any missing to determine that the set of grids G has the lower end of the certain length L1 or longer, and may also determine that the set of grids G has the lower end of the certain length L1 or longer, on an assumption that the density of grids G included in the lower end is equal to or greater than a reference value.

Next, when the area controller 136 has identified the set of grids G having the lower end of a certain length L1 or longer, it determines whether the set of grids G has a height of a certain length L2 or longer. That is, by determining whether the set of grids G has the lower end of the certain length L1 or longer and the height of the certain length L2 or longer, it is possible to specify whether the set of grids G corresponds to an object such as a motorcycle, a pedestrian, or a four-wheeled vehicle. In this case, a combination of the certain length L1 of the lower end and the certain length L2 of the height is set as a unique value for each object such as a motorcycle, a pedestrian, and a four-wheeled vehicle.

Next, when the area controller 136 has identified the set of grids G having the lower end of the certain length L1 or longer and the height of the certain length L2 or longer, the area controller 136 sets a bounding box for the set of grids G. Next, the area controller 136 determines whether the density of the grids G included in the set bounding box is equal to or greater than a threshold value. When the area controller 136 has determined that the density of the grids G included in the set bounding box is equal to or greater than the threshold value, it detects the bounding box as a target object and superimposes the detected area on the image IM10.

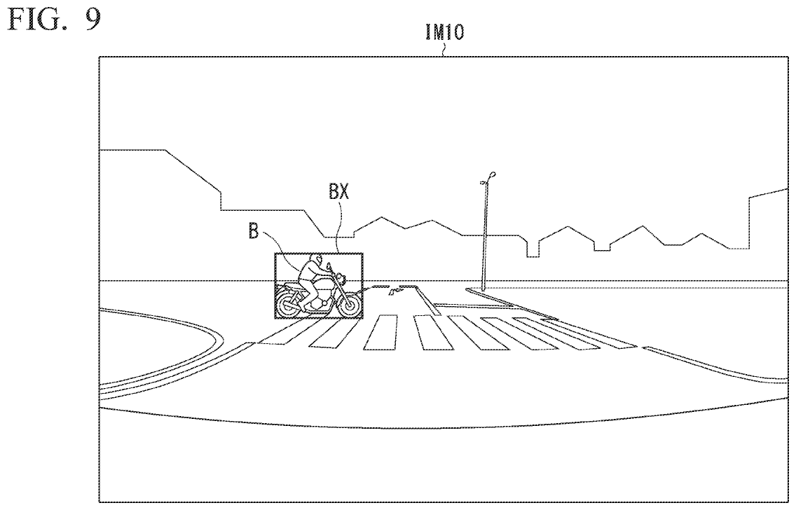

FIG. 9 is a diagram which shows an example of a bounding box BX superimposed on the image IM10. According to the processing described above, for example, the bounding box BX including an image area of the motorcycle B can be set more accurately as shown in FIG. 9. The image shown in FIG. 9 may be output to the HMI 30 by the HMI controller 150.

The area setter 130 may also set the bounding box BX based on the feature amount of the object in the image in a method using known artificial intelligence (AI), machine learning, or deep learning instead of (or in addition to) the method described above.

The area predictor 138 sets the position and size of an image area for tracking a motorcycle in the future image frame on the basis of an amount of time-series change in the bounding box BX including the motorcycle B in the past image frame and the behavior information of the host vehicle M. For example, the area predictor 138 estimates a position and a speed of the motorcycle B after a time point of recognition on the basis of an amount of change in the position of the motorcycle B in the past prior to the time point of recognition of the motorcycle B by the recognizer 120, and sets the position and size of an image area for tracking the motorcycle B in the future image frame on the basis of the estimated position and speed, and the behavior information of the host vehicle M (for example, position, speed, yaw rate) in the past prior to the time point of recognition.

The object tracker 140 tracks the motorcycle B in a next image frame on the basis of the amount of time-series change in the image area set by the area setter 130. For example, the object tracker 140 searches for the motorcycle B in the image area (bounding box) predicted by the area predictor 138, recognizes that an object in the bounding box is the motorcycle B when a degree of matching between a feature amount of the motorcycle B and a feature amount of the object in the bounding box is equal to or greater than a predetermined degree (threshold value), and tracks the motorcycle B.

The object tracker 140 uses a kernelized correlation filter (KCF) as a tracking method of an object. A KCF is a type of object tracking algorithm that returns the most responsive area in an image using a filter that is trained at any time based on a frequency component of an image when a continuous image and an attention area to be tracked in the image are input.

For example, a KCF can learn and track an object at a high speed while suppressing a memory usage amount or the like by a fast Fourier transform (FFT). For example, a tracking method using a general two-class identifier performs identification processing by randomly sampling a search window from the vicinity of a predicted position of the object. On the other hand, the KCF analytically processes an image group in which the search window is densely shifted by one pixel by an FFT, and therefore it can realize faster processing than the method using the two-class identifier.

The tracking method is not limited to a KCF, and for example, Boosting, Channel and Spatial Reliability Tracking (CSRT) MEDIANFLOW, Tracking Learning Detection (TLD), Multiple Instance Learning (MIL), or the like may be used. However, among these object tracking algorithms, an object tracking algorithm using a KCF is most preferable from a viewpoint of tracking accuracy and processing speed.

Particularly in the field of performing traveling control of the host vehicle M (automated driving and driving support), since rapid and highly accurate control according to the surrounding situation of the host vehicle M is an important factor, a KCF as in the embodiment is particularly effective.

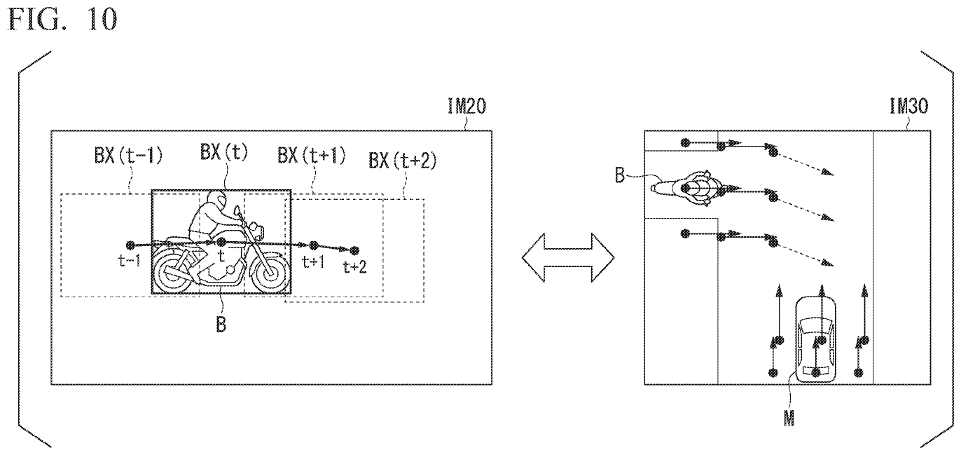

Next, setting of an image area by the area predictor 138 and tracking processing in the set image area will be described. FIG. 10 is a schematic diagram for describing the setting of an image area and the tracking processing. In an example of FIG. 10, a frame IM20 of a camera image at a current time (t) and a bounding box BX(t) including the motorcycle B at the current time (t) are shown.

The area predictor 138 obtains the amount of change in the position and size of a bounding box between frames on the basis of the position and size of the bounding box BX(t) recognized by the recognizer 120 and the position and size of a bounding box BX(t−1) recognized in an image frame at a past time (t−1). Next, the area predictor 138 estimates the position and size of bounding boxes BX(t+1) and BX(t+2), which are attention areas in the future (for example, a next frame (a time (t+1)), a next frame (t+2), and the like) on the basis of the obtained amount of change. The object tracker 140 searches for an area whose degree of matching with a previously recognized feature amount is equal to or greater than a predetermined degree on the basis of the estimated bounding boxes BX(t+1) and BX(t+2), and recognizes an area with a predetermined degree or more as the motorcycle B. In this manner, even if the size of an object on an image is deformed due to a difference in direction or angle, or the like according to the behavior of the host vehicle M or the behavior of the object, it is possible to recognize the motorcycle B with high accuracy.

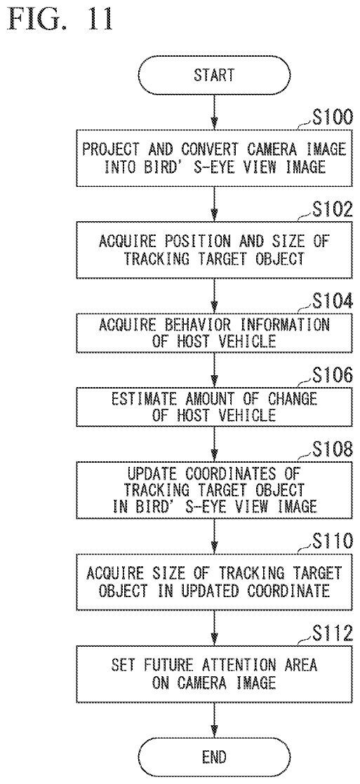

FIG. 11 is a flowchart which shows an example of area setting processing by the area predictor 138. In the example of FIG. 11, the area predictor 138 projects and converts a camera image (for example, the image IM20 in FIG. 10) acquired by the image acquirer 110 into a bird's-eye view image (an overhead view image) (for example, an image IM30 in FIG. 10) (step S100). In the processing of step S100, the area predictor 138 converts, for example, a coordinate system (a camera coordinate system) of a camera image at a front viewing angle into a coordinate system (a vehicle coordinate system) that is based on the position of the host vehicle M viewed from above. Next, the area predictor 138 acquires the position and size of a tracking target object (the motorcycle B in the example described above) from the converted image (step S102). Next, the area predictor 138 acquires the behavior information of the host vehicle M (for example, speed, yaw rate) in the past several frames by the vehicle sensor 40 (step S104), and estimates the amount of change in the position and speed of the host vehicle M on the basis of the acquired behavior information (step S106). In the processing of step S106, for example, by performing processing such as the Kalman filter or linear interpolation on the behavior information, it is possible to estimate the amount of change with higher accuracy.

Next, the area predictor 138 updates future coordinates (the position) of the motorcycle B in a bird's-eye view image on the basis of the estimated amount of change (step S108). Next, the area predictor 138 acquires a size of the tracking target object in the updated coordinates from the size of the tracking target object acquired in the processing of step S102 (step S110), and sets a future image area (an attention area for tracking) that is estimated to include the tracking target object on the camera image in the future by associating the position and size of the future tracking target object with the camera image (step S112). As a result, the processing of this flowchart ends. By recognizing an object in the next frame in an attention area set in this manner, a possibility that a tracking target object (the motorcycle B) is included in the attention area increases, so that the tracking accuracy can be further improved.

The traveling control device 200 estimates a risk of contact between the motorcycle and the host vehicle M on the basis of a result of tracking by the object tracker 140 and the behavior information of the host vehicle M. Specifically, the traveling control device 200 derives a contact margin time TTC (Time To Collision) using a relative position (a relative distance) and a relative speed between the host vehicle M and the motorcycle B, and determines whether the derived contact margin time TTC is less than a threshold value. The contact margin time TTC is, for example, a value calculated by dividing the relative distance by the relative speed. When the contact margin time TTC is less than the threshold value, the traveling control device 200 assumes that there is a possibility that the host vehicle M and the motorcycle B will come into contact with each other, and causes the host vehicle M to perform traveling control for contact avoidance. In this case, the traveling control device 200 generates a trajectory of the host vehicle M so as to avoid the motorcycle B detected by the object tracker 140 using steering control, and causes the host vehicle M to travel along the generated trajectory. The area predictor 138 may also increase the size of an image area of a tracking target in the next image frame when the host vehicle M travels to avoid contact with the motorcycle B, compared to the size when the host vehicle does not travel to avoid contact. As a result, even when the behavior of the host vehicle M greatly changes due to the contact avoidance control, it is possible to suppress deterioration of the tracking accuracy of a tracking target object.

Instead of (or in addition to) the steering control described above, the traveling control device 200 may cause the host vehicle M to stop before a position of the motorcycle B (before a crosswalk shown in FIG. 2) until the motorcycle B crosses the road RD1. The traveling control device 200 may determine that the host vehicle M and the motorcycle B do not come into contact and may not perform contact avoidance control when the contact margin time TTC is equal to or greater than the threshold value. Accordingly, in the present embodiment, a result of the detection by the object tracking device 100 can be suitably used for automated driving or driving assistance of the host vehicle M.

The HMI controller 150 outputs, for example, the content executed by the traveling control device 200 to the HMI 30 to notify the occupant of the host vehicle M of it. When an object is detected, the HMI controller 150 may display the detected content and predicted position and size of the bounding box on the HMI 30 to notify the occupant of them. As a result, the occupant can grasp how the host vehicle M predicts future behaviors of surrounding objects.

[Processing flow]

Next, a flow of processing executed by the object tracking device 100 of the embodiment will be described. The processing of this flowchart may be repeatedly executed, for example, at predetermined timings.

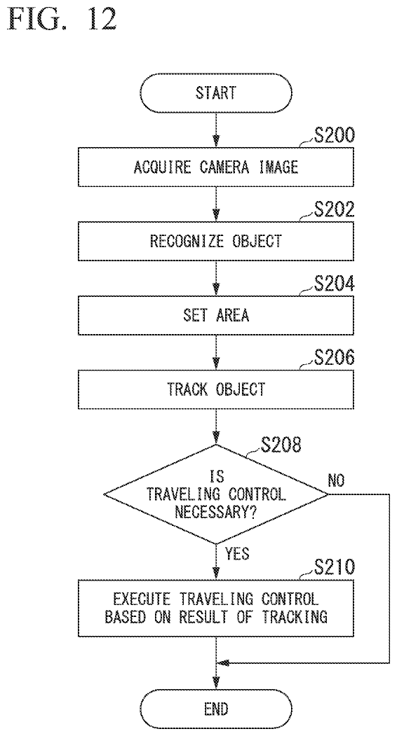

FIG. 12 is a flowchart which shows an example of the flow of driving control processing executed by the object tracking device 100. In the example of FIG. 12, the image acquirer 110 acquires a camera image (step S200). Next, recognizer 120 recognizes an object from the camera image (step S202). Next, the area setter 130 sets an image area (an attention area) for tracking the object from the camera image on the basis of a position and a size of the object (step S204). Next, the area is predicted and the object is tracked using the predicted area (step S206).

Next, the traveling control device 200 determines whether traveling control of the host vehicle M is necessary on the basis of a result of the tracking (step S208).

When it is determined that traveling control is necessary, the traveling control device 200 executes traveling control based on the result of the tracking (step S210). For example, the processing of step S210 is avoidance control that is executed when it is determined that there is a possibility that host vehicle M and the object will come into contact with each other in the near future. In the processing of step S210, traveling control including a result of the recognition of the surrounding situation of the host vehicle M by the recognizer 120 is executed. As a result, processing of this flowchart will end. In the processing of step S208, when it is determined that the traveling control is not necessary, the processing of this flowchart ends.

According to the embodiment described above, the object tracking device 100 includes the image acquirer 110 that acquires image data including a plurality of image frames captured in time series by an imager mounted on a mobile object, the recognizer 120 that recognizes an object from an image acquired by the image acquirer 110, the area setter 130 that sets an image area including the object recognized by the recognizer 120, and the object tracker 140 that tracks the object on the basis of the amount of time-series change of the image area set by the area setter 130, and the area setter 130 sets the position and size of an image area for tracking an object in a future image frame on the basis of the amount of time-series change in the image area including the object in the past image frame and the behavior information of a mobile object, and thereby it is possible to further improve the tracking accuracy of an object present in the vicinity of a vehicle.

According to the embodiment, it is possible to further increase a possibility that a tracking target object is included in an attention area, and it is possible to further improve tracking accuracy in each frame by correcting the position and a size of an area to be used as the attention area in a next frame when an image frame is updated on the basis of the behavior information of the host vehicle.

According to the embodiment, the tracking accuracy can be further improved by performing a correction that reflects the behavior of a mobile object in object tracking processing by a KCF, using an image of a camera mounted on the mobile object (moving camera) as an input. For example, according to the embodiment, adjustment processing of an attention area (an image area of a tracking target) according to the behavior of the host vehicle based on the KCF is added to track the target object, and thereby it is possible to perform tracking by flexibly responding to changes in the position and size of an apparent object between frames of the camera 10. Therefore, tracking accuracy can be improved more than object tracking using preset template matching.

The embodiment described above can be expressed as follows.

An object tracking device includes a storage medium that stores instructions readable by a computer, and a processor connected to the storage medium, the processor executes the instructions readable by the computer, thereby acquiring image data including a plurality of image frames captured in time series by an imager mounted on a mobile object, recognizing an object from the acquired image, setting an image area including the recognized object, tracking the object on the basis of an amount of time-series changes in the set image area, and setting a position and a size of an image area for tracking the object in the future image frame on the basis of the amount of time-series change in an image area including the object in the past image frame and behavior information of the mobile object.

As described above, a mode for implementing the present invention has been described using the embodiments, but the present invention is not limited to such embodiments at all, and various modifications and replacements can be added within a range not departing from the gist of the present invention.

What is claimed is:

1. An object tracking device comprising:
an image acquirer configured to acquire image data including a plurality of image frames captured in time series by an imager mounted on a mobile object;
a recognizer configured to recognize an object from image data acquired by the image acquirer;
an area setter configured to set an image area including an object recognized by the recognizer; and
an object tracker configured to track the object on the basis of an amount of time-series change in an image area set by the area setter,
wherein the area setter sets a position and a size of an image area for tracking the object in the future image frame on the basis of the amount of time-series change in an image area including the object in the past image frame and behavior information of the mobile object.

2. The object tracking device according to claim 1,
wherein the area setter estimates a position and a speed of an object after a time point of recognition on the basis of an amount of change in the position of the object in the past prior to the time point of recognition of the object by the recognizer, and sets a position and a size of an image area for tracking the object in a future image frame on the basis of the estimated position and speed, and behavior information of the mobile object in the past prior to the time point of recognition.

3. The object tracking device according to claim 1,
wherein, when the object is recognized by the recognizer, the area setter projects and converts an image captured by the imager into a bird's-eye view image, acquires a position and a size of the object in the bird's-eye view image, estimates a future position of the object in the bird's-eye view image on the basis of the acquired position and size of the object and the behavior information of the mobile object, and sets the position and size of an image area for tracking the object in a next image frame by associating the estimated position with the captured image.

4. The object tracking device according to claim 1,
wherein the object tracker uses a kernelized correlation filter (KCF) for the tracking of the object.

5. The object tracking device according to claim 1,
wherein the area setter increases the size of the image area when the mobile object travels to avoid contact with the object, compared to the size when the mobile object does not travel to avoid the contact.

6. An object tracking method comprising:
by a computer,
acquiring image data including a plurality of image frames captured in time series by an imager mounted on a mobile object;
recognizing an object from the acquired image data;
setting an image area including the recognized object;
tracking the object on the basis of an amount of time-series change in the set image area; and
setting a position and a size of an image area for tracking the object in a future image frame on the basis of the amount of time-series change in an image area including the object in a past image frame and behavior information of the mobile object.

7. A computer-readable non-transitory storage medium that has stored a program causing a computer to execute
acquiring image data including a plurality of image frames captured in time series by an imager mounted on a mobile object;
recognizing an object from the acquired image data;
setting an image area including the recognized object;
tracking the object on the basis of an amount of time-series change in the set image area; and
setting a position and a size of an image area for tracking the object in a future image frame on the basis of the amount of time-series change in an image area including the object in a past image frame and behavior information of the mobile object.
